(19) United States
(12) Patent Application Publication
(10) Pub. No.: US 2010/0294743 A1
(43) Pub. Date: Nov. 25, 2010

(54) ELECTRIC DISCHARGE DEVICE

(75) Inventors: Takashi Hashimoto, Chiyoda-ku (JP); Koichiro Hattori, Chiyoda-ku (JP); Takashi Yuzawa, Chiyoda-ku (JP); Yoshikazu Ukai, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Chiyoda-ku, Tokyo (JP)

(21) Appl. No.: 12/864,195

(22) PCT Filed: Jan. 31, 2008
(86) PCT No.: PCT/JP2008/051554

§ 371 Date: Jul. 22, 2010

(51) Int. Cl. B23K 15/00

(52) U.S. Cl. 219/121.34

(57) ABSTRACT

To provide an electric discharge device capable of performing an optimum process that achieves a high-quality process in a satisfactory quality of processing precision and the like. In an electric discharge device that processes a workpiece by electric discharge, a reserve electric-discharge pulse is applied by alternately switching between a positive polarity and a reverse polarity, and a current waveform shape of a main electric-discharge pulse is differentiated corresponding to a polarity of a reserve electric-discharge pulse, to a main electric-discharge pulse to be applied after detecting electric discharge following the reserve electric-discharge pulse. With this arrangement, a processing current shape can be optimized corresponding to an electric discharge characteristic, and thus a high-precision process can be performed.

### TECHNICAL FIELD

The present invention relates to an electric discharge device that processes a workpiece by electric discharge, and more particularly to an electric discharge device that performs processing by combining two kinds of electric discharge pulses including a reserve electric-discharge pulse and a main electric-discharge pulse, which are alternately applied.

### BACKGROUND ART

An electric discharge device is a device that processes a workpiece by generating an arc discharge by applying a voltage between a process electrode and the workpiece. As the electric discharge device, there is a wire electric discharge device that processes a workpiece by using an arc discharge generated in a gap between a wire electrode and the workpiece in a processing liquid by using a thin metal wire for the process electrode.

In the electric discharge device, a processing pulse is applied in a gap between an electrode and a workpiece (hereinafter, the gap is also referred to as “interelectrode”) to generate an arc discharge. This processing pulse is sometimes configured by a reserve electric-discharge pulse to induce and detect electric discharge generated by a circuit configuration having a high impedance, and a main electric-discharge pulse applied mainly to process the workpiece after the generated electric discharge is detected. The main electric-discharge pulse is generated by a circuit configuration having a low impedance. For example, Patent Document 1 discloses a conventional technique of performing an electric discharge process by combining a reserve electric-discharge pulse and a main electric-discharge pulse.

Patent Document 1 describes a wire electric discharge device provided in a circuit including a first direct-current power source as a main electric-discharge power source to apply a main electric-discharge pulse, and second and third direct-current power sources as reserve electric-discharge power sources respectively to apply a reserve electric-discharge pulse: a main electric-discharge circuit having a first switch and a first direct-current power source connected in series, having a positive electrode side of the first direct-current power source connected to a workpiece, and having a negative electrode side connected to an electrode; a reserve electric-discharge circuit of a negative polarity having a second switch and a second direct-current power source connected in series, having a positive electrode side of the second direct-current power source connected to an electrode, and having a negative electrode side connected to the workpiece; and a reserve electric-discharge circuit of a positive polarity having a third switch and a third direct-current power source connected in series, having a positive electrode side of the third direct-current power source connected to the workpiece, and having a negative electrode side connected to the electrode. The reserve electric-discharge circuits of the positive polarity and the negative polarity are closed alternately, and a main electric-discharge current of the main electric-discharge circuit is superimposed with an electric discharge current of a positive polarity flowing between electrodes by turning on the first switch in both cases.

In this conventional electric discharge device, a reserve electric-discharge pulse is generated by alternately using the second direct-current power source and the third direct-current power source, thereby mutually replacing polarities applied to the wire electrode and the workpiece. This has an effect of preventing an electric corrosion at the time of using water for a processing liquid. That is, at the time of performing processing in a direct current, when an average value of an interelectrode voltage is not zero having a polarity, an electrical field current flows via the processing liquid and a surface of a workpiece softens. However, by alternately using the second direct-current power source and the third direct-current power source, an absolute value of an average voltage between electrodes can be set close to zero, thereby preventing the surface of the workpiece from softening. Meanwhile, an arc discharge is known to have different processing characteristics between a cathode and an anode. That is, processing characteristics are different depending on whether a workpiece is processed as a cathode or a workpiece is processed as an anode. Therefore, a main electric-discharge pulse, which greatly contributes to processing, is generated based on “positive polarity” using a workpiece as a positive electrode and a wire electrode as a negative electrode. In the following descriptions, a polarity when a workpiece is a positive electrode and an electrode is a negative electrode is called “positive polarity”, and a polarity when a workpiece is a negative electrode and an electrode is a positive electrode is called “reverse polarity (or negative polarity)”.

In Patent Document 1, when the second switch is turned on, a current flows to the reserve electric-discharge circuit of a negative polarity, and a reserve electric-discharge pulse is applied in a gap between the electrodes. Next, when the second switch is turned off and the first switch is turned on at a time when electric discharge is detected, a current flows to the main electric-discharge circuit, and a main electric-discharge pulse is supplied in a gap between electrodes. A pulse width of the main electric-discharge pulse is assumed here as a period t2. A pause time is then provided, during which a current flowing in a floating reactor is regenerated and a current is down between electrodes at the same time when the main electric-discharge pulse is stopped. Thereafter, when the third switch is turned on, a current flows in the reserve electric-discharge circuit of a positive polarity, and a reserve electric-discharge pulse of a polarity different from a preceding polarity is applied in a gap between electrodes. When the third switch is turned off at the time when electric discharge is detected and also when the first switch is maintained to be on during the period t2, a main electric-discharge pulse is applied in a gap between electrodes. This operation is repeated until when the processing ends.

Processing is generally performed by sequentially decreasing energy mainly in the order of a rough process, an intermediate finishing process, a finishing process, and a super-finishing process. That is, the pulse width t2 of a main electric-discharge pulse is the largest at the time of a rough process, and becomes sequentially smaller in the order of an intermediate finishing process and a finishing process. Alternatively, in a finishing process and a super-finishing process, processing may be sometimes performed using only a reserve electric-discharge pulse without applying a main electric-discharge pulse.

Patent Document 1: Japanese Patent No. 3436019

### DISCLOSURE OF INVENTION

### Problem to be Solved by the Invention

In Patent Document 1, regardless of the polarity at an application time of the reserve electric-discharge pulse, a main electric-discharge pulse applied after a reserve electric-discharge pulse is maintained to be on during the period t2 when the pulse has the same pulse width. However, because electric discharge characteristics are different between a cathode and an anode, electric discharge at an application time of a reserve electric-discharge pulse may be also considered to be in a different electric discharge mode. For example, when a workpiece works as a cathode, the electric discharge mode has a shape of a small diameter in a high current density having a cathode spot, and when the workpiece works as an anode, the electric discharge mode has a shape of a large diameter in a low current density. Therefore, although the main electric-discharge pulse after an application of the reserve electric-discharge pulse is standardized in a positive polarity process, in an initial period of the main electric-discharge pulse, the main electric-discharge pulse may be considered to drag an electric-discharge characteristic when the reserve electric-discharge pulse is applied. Particularly, when an electric discharge current of a main electric-discharge pulse in a finishing process and the like becomes smaller, the difference between a reserve electric-discharge pulse and a processing current (processing energy) also becomes smaller. Therefore, influence of an electric discharge state at a reserve electric-discharge time may be considered to remain significant due to the size of the difference. In this way, when the difference of electric-discharge characteristics at the reserve electric-discharge time affects the application time of the main electric-discharge pulse, an application of a conventional processing method does not make it possible to perform an optimum process.

Not only an arc discharge characteristic changes depending on a polarity applied to an electrode, but also an electric-discharge start voltage changes depending on a material of the electrode. That is, when materials of electrodes are different, electric-discharge start voltages may be also considered to be different. The difference of electric-discharge start voltages appears as a difference of electric-discharge delay times which is a difference of times until when electric discharge is started. Although an interelectrode voltage is an important index to understand an interelectrode distance, the interelectrode distance cannot be maintained in high precision when a difference occurs in the interelectrode voltage depending on a material of an electrode. Therefore, this leads to degrading in a processing quality such as wire disconnection or a processing precision failure.

The present invention has been achieved in view of the above problems, and an object of the present invention is to provide an electric discharge device capable of performing an optimum process such as realizing processing of a high quality in high processing precision.

### Means for Solving Problem

To solve the above problems and achieve the object, an electric discharge device that performs an electric discharge process by applying in a gap between a process electrode and a workpiece a reserve electric-discharge pulse output by alternately switching polarities and a main electric-discharge pulse output after detecting electric discharge by the reserve electric-discharge pulse; wherein the electric discharge device outputs main electric-discharge pulses by setting mutually different current waveform shapes to a main electric-discharge pulse applied following a reserve electric-discharge pulse in a positive polarity output by setting the workpiece as a positive electrode and the process electrode as a negative electrode, and to a main electric-discharge pulse applied following a reserve electric-discharge pulse in a reverse polarity output by setting the workpiece as a negative electrode and the process electrode as a positive electrode.

### EFFECT OF THE INVENTION

According to the present invention, in an electric discharge device that performs processing by combining a reserve electric-discharge pulse and a main electric-discharge pulse of which polarities are alternately switched, an optimum process corresponding to an electric discharge characteristic may be performed and a high-precision process may be performed. The optimum process may be performed by changing a current waveform shape of a main electric-discharge pulse, which is applied after the reserve electric-discharge, and according to polarities of the reserve electric-discharge time and by setting current waveform shapes of the main electric-discharge pulses such that each of the current waveform shapes is different from the others.

### BRIEF DESCRIPTION OF DRAWINGS

FIG. 1 depicts a schematic configuration of an electric discharge device according to an embodiment of the present invention.

FIG. 2 is an example of a switching signal waveform output from a control unit, and depicts an interelectrode voltage waveform and an interelectrode current waveform in this example.

FIG. 3 is a table of a comparison between characteristics of a positive polarity process and those of a reverse polarity process.

FIG. 4 is a circuit configuration diagram of a wire electric discharge device described in Patent Document 1.

FIG. 5 depicts a switching signal waveform described in Patent Document 1.

### EXPLANATIONS OF LETTERS OR NUMERALS

1 Electric discharge device
3 Power source-unit-and-electric-discharge-unit
4 Control unit
7 First direct-current power source
8 Second direct-current power source
9 Third direct-current power source
11 Workpiece
12 Process electrode
30 Process parameter
31 Operation-identification processing unit
32 Upper level controller
101 Electrode
102 Workpiece
103 First switch
104 First direct-current power source
105 Electrically conductive chip
106 Surge-voltage absorbing circuit
107, 124, 125, 126 Diode
108 Second switch
109 Second direct-current power source
110, 114, 122 Resistor
112 Capacitor
113 Inductor
115 Control circuit
116, 117, 123 Drive circuit
120 Third switch
121 Third direct-current power source
127, 128 Signal line

### BEST MODE(S) FOR CARRYING OUT THE INVENTION

Exemplary embodiments of an electric discharge device according to the present invention will be explained below in detail with reference to the accompanying drawings. The present invention is not limited to the embodiments.

### Embodiments

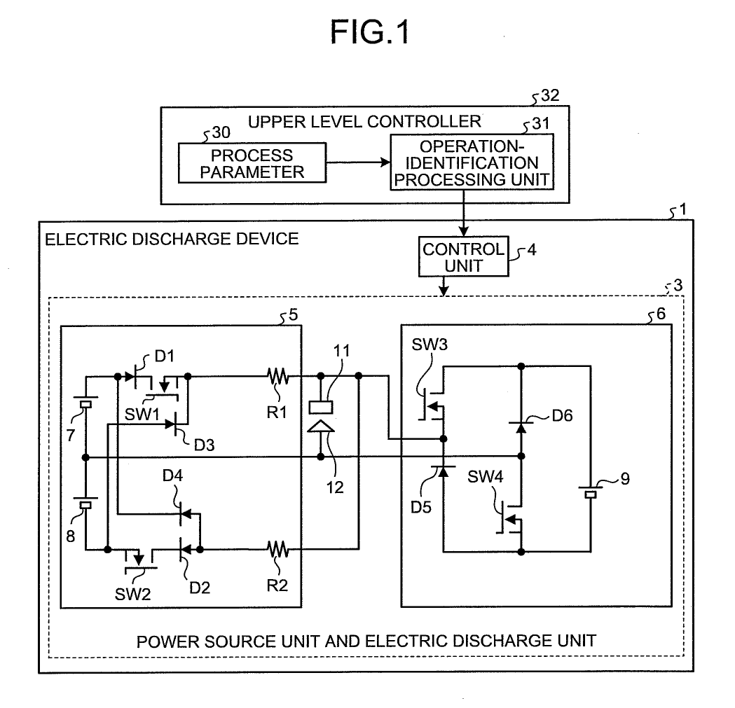

FIG. 1 depicts a schematic configuration of an electric discharge device according to an embodiment of the present invention, and is a functional block diagram centering a power source unit. In FIG. 1, an electric discharge device 1 includes the power source unit, an electric discharge unit 3, and a control unit 4.

The power-source-unit-and-the-electric-discharge-unit 3 includes a power source unit, and the power source unit specifically includes a reserve electric-discharge power-source 5 (also called “sub-power source”) and a main electric-discharge power-source 6 (also called “main power source”). The reserve electric-discharge power-source 5 (also called “sub-power source”) and the main electric-discharge power-source 6 apply a reserve electric-discharge pulse and a main electric-discharge pulse described later, respectively to between electrodes (that is, interelectrode) of a workpiece 11 and an electrode 12 as a process electrode. These timings are controlled by the control unit 4.

More specifically, the reserve electric-discharge power-source 5 includes a first power source 7 as a direct-current power source, a second power source 8 as a direct-current power source, switching elements SW1 and SW2 of an FET or the like, diodes D1, D2, D3, and D4, and current limit resistors R1 and R2.

A + (plus) terminal of the first power source 7 is connected to an anode of the diode D1, and a − (minus) terminal is connected to a + terminal of the second power source 8. A cathode of the diode D1 is connected to a drain of the switching element SW1, and a source of the switching element SW1 is connected to the current limit resistor R1. Similarly, the current limit resistor R2 is connected to an anode of the diode D2, and a cathode of the diode D2 is connected to a drain of the switching element SW2. A source of the switching element SW2 is connected to − (minus) terminal of the second power source 8. The − (minus) terminal of the second power source is connected to an anode of the diode D3, and a cathode side of the diode D3 is connected to the current limit resistor R1. Similarly, the current limit resistor R2 is connected to an anode of the diode D4, and a cathode of the diode D4 is connected to a + terminal of the first power source 7.

A connection point that connects − (minus) terminal of the first power source 7 and the + (plus) terminal of the second power source is connected to the electrode 12. An end part of the current limit resistor R1 at a side not connected to the switching element SW1 is connected to the workpiece 11, and an end part of the current limit resistor R2 at a side not connected to the diode D2 is also connected to the workpiece 11.

The first power source 7 applies a reserve electric-discharge pulse A, which is in a positive polarity, to the workpiece 11 via the switching element SW1 and to the electrode 12. The second power source 8 applies a reserve electric-discharge pulse B, which is in a reverse polarity, to the workpiece 11 via the switching element SW2 and to the electrode 12. In this case, because the first power source 7 and the second power source 8 are separate power sources, a voltage of the reserve electric-discharge pulse A and a voltage of the reserve electric-discharge pulse B can be arbitrarily adjusted.

Because a current flows through the current limit resistor R1 and the current limit resistor R2, respectively when the reserve electric-discharge pulse A and the reserve electric-discharge pulse B are applied, magnitudes of these currents can be adjusted by designing resistances of the current limit resistor R1 and the current limit resistor R2 at separate values.

Meanwhile, the main electric-discharge power-source 6 is configured to include a third power source 9 as a direct-current power source, switching elements SW3 and SW4, and diodes D5 and D6. A drain of the switching element SW3 is connected to a +terminal of the third power source 9. A source of the switching element SW3 is connected to a cathode of the diode D5, and a connection point of the source and the cathode is connected to the workpiece 11. A source of the switching element SW4 is connected to − (minus) terminal of the third power source 9. A drain of the switching element SW4 is connected to an anode of the diode D6, and a connection point of the drain and the anode is connected to the electrode 12. Based on this configuration, a main electric-discharge pulse that is in a positive polarity is output from the main electric-discharge power-source 6 by turning ON/OFF the switching elements SW3 and SW4.

On the other hand, an upper level controller 32 that includes a process parameter 30 and an operation-identification processing unit 31 is provided at outside of the electric discharge device 1. The process parameter 30 includes information indicating a processing operation and a processing condition. The operation-identification processing unit 31 identifies control information (hereinafter, “process information”) necessary to perform an electric discharge process, based on information of the process parameter 30, and transmits the control information to the control unit 4. The control information in this case includes information regarding which one of elements such as processing speed, surface roughness, electrode consumption, and straightness, are to be prioritized.

The control unit 4 determines processing power to be applied in a gap between the workpiece 11 and the process electrode 12 by using process information output from the operation-identification processing unit 31. The control unit 4 also determines a pulse width (a pulse application time), a pulse pause width (a pulse pause time), and a combination pattern of these items of a pulse signal for conducting switching-control of the switching elements SW1 to SW4. The switching elements SW1 to SW4 are controlled based on a switching signal output from the control unit 4, and a desired interelectrode voltage and an interelectrode current are supplied between the workpiece 11 and the process electrode 12 at arbitrary waveform timings.

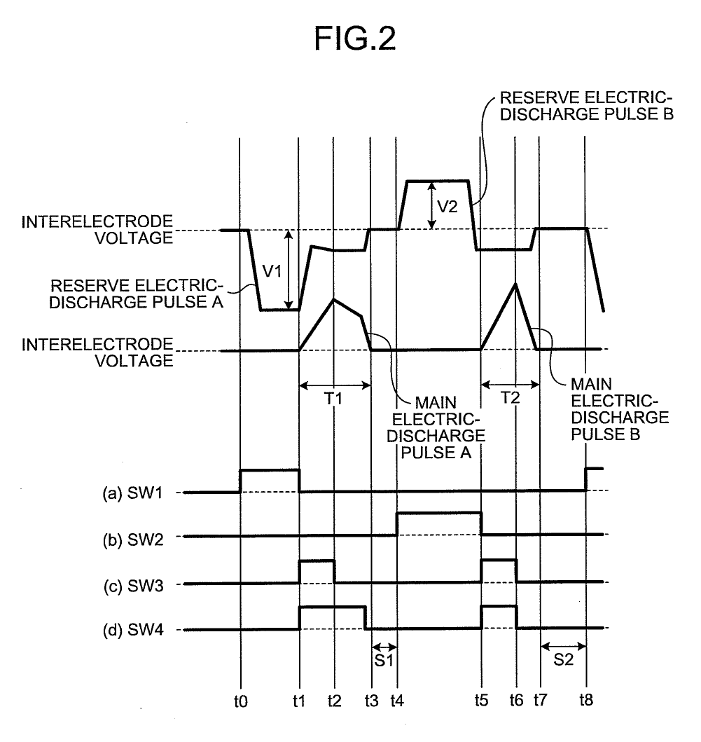

FIG. 2 is an example of a switching signal waveform output from the control unit 4, and depicts an interelectrode voltage waveform and an interelectrode current waveform in this example. More specifically, (a) to (d) in FIG. 2 represent switching signals applied to the switching elements SW1 to SW4, respectively.

When the switching element SW1 is turned on at a time to, a current flows through a route of the first power source 7→the diode D1→the switching element SW1→the current limit resistor R1→the workpiece 11→the electrode 12→the first power source 7, and a reserve electric-discharge pulse is output between electrodes. The reserve electric-discharge pulse in this case is a reserve electric-discharge pulse in a positive polarity when the workpiece 11 becomes a positive electrode and the electrode 12 becomes a negative electrode. This reserve electric-discharge pulse is called the reserve electric-discharge pulse A to distinguish this from a reserve electric-discharge pulse in a reverse polarity described later. When the workpiece 11 and the electrode 12 are in an insulated state (a non-electric discharge state), the reserve electric-discharge pulse A in a positive polarity appears between electrodes as a voltage pulse. The reserve electric-discharge pulse A between times t0 and t1 is set such that a voltage value of this interelectrode voltage becomes V1.

When electric discharge is detected at a time t1, the switching element SW3 and the switching element SW4 are turned on simultaneously with a turning off of the switching element SW1. Electric discharge may be detected by detecting a current that follows the start of electric discharge, with a current detector (not shown) provided in the power-source-unit-and-the-electric-discharge-unit 3, for example. As a result, a current flows through a route of the third power source 9→the switching element SW3→the workpiece 11→the electrode 12→the switching element SW4→the third power source 9, and a main electric-discharge pulse is output between electrodes. A main electric-discharge pulse of which electric discharge is induced by the reserve electric-discharge pulse A and which is applied following the reserve electric-discharge pulse A is called a main electric-discharge pulse A. During an application of the main electric-discharge pulse A, when the switching element SW3 is turned off at a time t2, a current flowing through the workpiece 11 and the electrode 12 is refluxed through a route of the workpiece 11→the electrode 12→the switching element SW4→the diode D5→the workpiece 11 based on a floating inductance component. When the switching element SW4 is also turned off immediately before a time t3, a current is regenerated to a power source side through a route of the workpiece 11→the electrode 12→the diode D6→the third power source 9→the diode D5→the workpiece 11. The main electric-discharge pulse A is kept applied during a period T1 as shown by the interelectrode current waveform in FIG. 2.

The switching element SW2 is turned on at a time t4 after a pause period S1 from the time t3. As a result, a current flows through a route of the second power source 8→the electrode 12→the workpiece 11→the current limit resistor R2→the diode D2→the switching element SW2→the second power source 8, and the reserve electric-discharge pulse B is output between electrodes. When the workpiece 11 and the electrode 12 are in an insulated state (a non-electric discharge state), the reserve electric-discharge pulse B in a reverse polarity appears between electrodes as a voltage pulse. The reserve electric-discharge pulse B between times t4 and t5 is set such that a voltage value of this interelectrode voltage becomes V2. V2 can be set at a value independent of V1 described above, that is, V2 and V1 can be set at different values from each other in general.

Next, when electric discharge is detected at a time t5, the switching element SW3 and the switching element SW4 are turned on simultaneously with a turning off of the switching element SW2. As a result, a current starts flowing between electrodes in a similar manner to that of the main electric-discharge pulse A. A main electric-discharge pulse of which electric discharge is induced by the reserve electric-discharge pulse B and which is applied following the reserve electric-discharge pulse B is called a main electric-discharge pulse B. The main electric-discharge pulse B is kept applied during a period T2 as shown by the interelectrode current waveform in FIG. 2.

A reflux period is not provided in the main electric-discharge pulse B. Accordingly, the switching element SW3 and the switching element SW4 are turned off simultaneously at a time t6. A current flowing between electrodes is regenerated to a power source side through a route of the workpiece 11→the electrode 12→the diode D6→the third power source 9→the diode 5→the workpiece 11, and an approximately triangular wave shape is obtained as an interelectrode current waveform during times t5 and t7 (the period T2).

When the switching element SW1 is turned on at a time t8 after a pause period S2 from a time t7, the reserve electric-discharge pulse A is applied, and a series of operation is repeated. S2 may be set independently of S1 described above.

As described above, a main electric-discharge current by an application of a main electric-discharge pulse continues flowing for some time during a period while a current regeneration time is present, even when the switching elements SW3 and SW4 are turned off. As a result, the pause times S1 and S2 become, as control timings, a time from when the switching elements SW3 and SW4 are simultaneously turned off to stop a main electric-discharge current until when the next reserve electric-discharge pulse is applied. Essentially (physically), the pause times S1 and S2 mean a time from when a main electric-discharge current ends (that is, from when a main electric-discharge current becomes zero) until when the next reserve electric-discharge pulse is applied (see periods S1 and S2 in FIG. 2). In this case, a time from when a main electric-discharge current (the main electric-discharge current A) by the main electric-discharge pulse A ends until when the reserve electric-discharge pulse B is applied is set as the pause time S1, and a time from when a main electric-discharge current (the main electric-discharge current B) by the main electric-discharge pulse B ends until when the reserve electric-discharge pulse A is applied is set as the pause time S2.

The first power source 7 to generate the reserve electric-discharge pulse A and the second power source 8 to generate the reserve electric-discharge pulse B are independent. Therefore, the reserve electric-discharge pulse A is set to the voltage value V1 and the reserve electric-discharge pulse B is set to the voltage value V2.

In the present embodiment, although the main electric-discharge pulse A has a reflux waveform and the main electric-discharge pulse B has a triangular waveform, the shapes and current peak values mentioned above are examples and these can be set arbitrarily.

Meanings of the reserve electric-discharge pulse A, the reserve electric-discharge pulse B, the main electric-discharge pulse A, the main electric-discharge pulse B, and the pause times S1 and S2 are explained below.

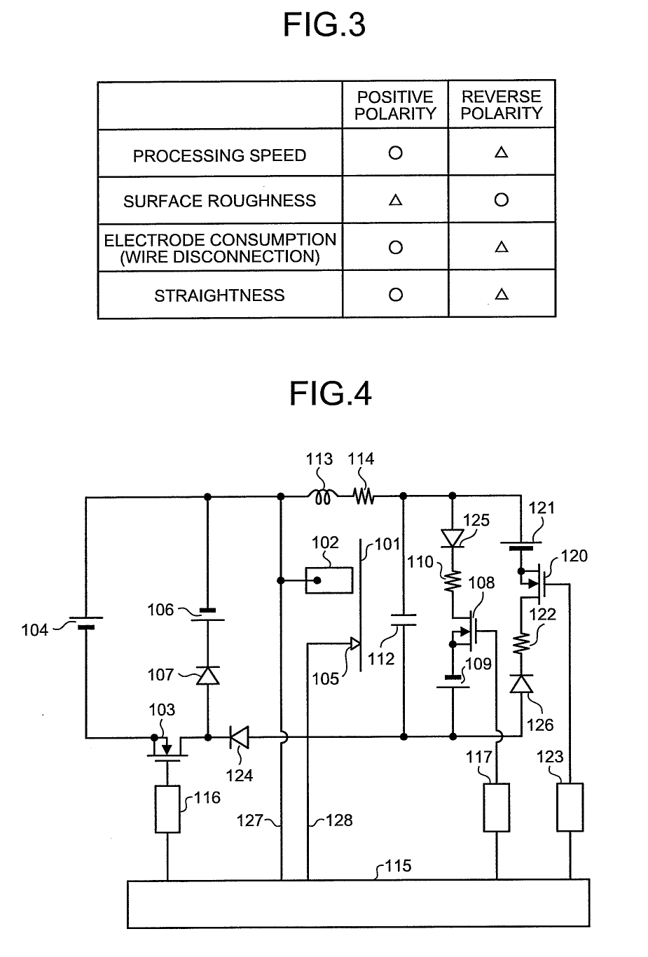

FIG. 3 is a table of a comparison between characteristics of a positive polarity process and those of a reverse polarity process. In FIG. 3, a circle indicates that this characteristic is superior to that of a triangle, and conversely, that a characteristic of a triangle is inferior to that of a circle. As is clear from FIG. 3, performing a positive polarity process is a preferable condition to perform processing prioritizing processing speed, electrode consumption (wire disconnection), and straightness. On the other hand, performing a reverse polarity process becomes a preferable condition to perform processing prioritizing surface roughness. A normal main electric-discharge power source pursues high-speed performance, and therefore processing is performed in a positive polarity. It is preferable for also a reserve electric-discharge power source to perform processing in only a positive polarity to obtain high-speed performance. However, it is known that when water is used for a processing liquid, performing processing in only one polarity causes an electric corrosion. Accordingly, an adjustment is generally performed by applying an alternate current waveform such that an average voltage between electrodes becomes 0 volt by using a reserve electric-discharge power source having an accessory role in the process.

The reason why processing characteristics in a positive polarity are different from those in a reverse polarity is believed that the way of spreading of electric discharge is different in an anode and a cathode. That is, the difference in current densities is different is believed to generate a difference in a processing state. A main electric-discharge pulse has a larger current value than that of a reserve electric-discharge pulse in general, and gives large influence to processing. That is, an effect of a positive polarity process mainly appears in the entire process. However, influence of a reserve electric-discharge current becomes relatively large in the case of processing (for example, a finishing process, and a thin line process) in which processing energy of a main electric-discharge pulse (determined by an electric charge amount, a current peak value, an application voltage, and a current pulse width) is small. That is, the processing characteristics described above such as processing speed, straightness, electrode consumption (wire disconnection), and surface roughness change corresponding to an application state of a reserve electric-discharge pulse. In the case of a positive polarity, processing works advantageously to processing speed, electrode consumption (wire disconnection), and straightness, whereas in the case of a reverse polarity, processing works advantageously to surface roughness.

Furthermore, a current of a main electric-discharge pulse in a positive polarity also is influenced by characteristics of a reserve electric-discharge pulse immediately before. For example, in the case of the main electric-discharge pulse A when a reserve electric-discharge pulse is in a positive polarity and also when a main electric-discharge pulse is in a positive polarity, a shape (a current density) of an electrode surface determined by reserve electric discharge directly becomes that of a main electric-discharge pulse. Therefore, it can be considered that reserve electric discharge itself has characteristics similar to those of a main electric-discharge pulse. However, in the case of the main electric-discharge pulse B when a reserve electric-discharge pulse is in a reverse polarity and also when a main electric-discharge pulse is in a positive polarity, a shape of an electrode surface in a reverse polarity shifts to a shape of an electrode surface in a positive polarity. Therefore, it may be considered that characteristics of a reverse polarity of the reserve electric-discharge pulse B remain during an initial period of an application of the main electric-discharge pulse B.

Although each electric discharge is independent, it is easily influenced by preceding electric discharge. When the reserve electric-discharge pulse A and the main electric-discharge pulse A are applied before an application of the reserve electric-discharge pulse B in a reverse polarity, and also when the pause time S1 thereafter is not sufficient, electric discharge is easily induced at the same position. Further, because a shape of an electrode surface in a positive polarity remains, it is not possible to sufficiently take advantage of a primary characteristic of a reverse polarity.

From the above points, to sufficiently take advantage of characteristics of a reverse polarity in processing, instead of simply setting a main electric-discharge characteristic in a positive polarity, it is preferable to (1) sufficiently take advantage of an electric discharge characteristic of a reserve electric-discharge pulse itself, (2) change a main electric-discharge pulse applied after a reserve electric-discharge pulse, corresponding to the characteristics of the reserve electric-discharge pulse, and (3) set a proper pause time between a main electric-discharge pulse and a reserve electric-discharge pulse to take advantage of characteristics of a reserve electric-discharge pulse applied after a main electric-discharge pulse.

<Sufficiently Taking Advantage of Capacity of Positive Polarity Process>

Because only the reserve electric-discharge pulse B works in a reverse polarity and also because the reserve electric-discharge pulse A, the main electric-discharge pulse A, and the main electric-discharge pulse B are in positive polarities, it is possible to sufficiently take advantage of capacity of a positive polarity process by changing parameters of the reserve electric-discharge pulse B and before and after the reserve electric-discharge pulse B. (1) When an electric discharge current electrically discharged by the reserve electric-discharge pulse B and an electric discharge current electrically discharged by the reserve electric-discharge pulse A are compared, the electric discharge current electrically discharged by the reserve electric-discharge pulse B is designed to be set smaller than the electric discharge current electrically discharged by the reserve electric-discharge pulse A. For example, the resistance of the current limit resistor R2 may be set larger than that of the current limit resistor R1, or the power source voltage V1 of the first power source 7 may be set higher than the power source voltage V2 of the second power source 8. However, when a power source voltage is increased, influence of an electric-discharge start voltage described later also needs to be considered. (2) An initial period of electric discharge of the main electric-discharge pulse B is easily influenced by a reverse polarity. Therefore, to take advantage of characteristics of a positive polarity, it is preferable to set large electric-discharge energy by setting a current peak value larger than the main electric-discharge pulse A and by setting a large electric discharge amount. That is, for the main electric-discharge pulse A and the main electric-discharge pulse B, a current peak value of the main electric-discharge pulse B is set larger, and current waveform shapes are mutually differentiated, for example. When input energy can be gained by applying the main electric-discharge pulse, energy of the main electric-discharge pulse B influenced by a reverse polarity may be set considerably small. However, because this depends on the processing environment such as a processing material, wire diameter, sheet thickness, and thus the design method cannot be determined unambiguously. (3) When the pause time S1 is set short, influence of the main electric-discharge pulse A of a positive polarity process can be extended to the reserve electric-discharge pulse B. Namely, characteristics of the reverse polarity may be reduced. The quantitative length of a pause time also changes according to the processing environment, and thus it cannot be determined unambiguously. However, it is preferable to set at least the pause time S1 shorter than the pause time S2.

<Sufficiently Taking Advantage of Capacity of Reverse Polarity Process>

Contrary to the above, it is possible to sufficiently take advantage of capacity of a reverse polarity process by changing parameters such that contributions of the reserve electric-discharge pulse A and the main electric-discharge pulse A thereafter become large. (1) An electric discharge current electrically discharged by the reserve electric-discharge pulse B is designed larger than an electric discharge current electrically discharged by the reserve electric-discharge pulse A. For example, the resistance of the current limit resistor R2 may be set smaller than that of the current limit resistor R1, or the power source voltage V1 of the first power source 7 may be set lower than the power source voltage V2 of the second power source 8. However, influence of an electric-discharge start voltage described later also needs to be considered in a similar manner to that described above. (2) An initial period of electric discharge of the main electric-discharge pulse B is influenced by a reverse polarity. Therefore, it is preferable to set low a current peak value of the main electric-discharge pulse B. To secure processing energy, processing energy may be increased in a state near a shape of an electrode surface of a reverse polarity in an initial period of electric discharge by using a reflux current. (3) Opposite to the positive polarity process, it is preferable to set the pause time S1 longer than the pause time S2. With this arrangement, influence of the main electric-discharge pulse A in a positive polarity given to the reserve electric-discharge pulse B in a reverse polarity may be suppressed.

However, the above described control is an example, and respective characteristics are different according to a pause time and a processing material. Therefore, preferable control depends on each case.

According to the present embodiment, when an electric discharge process is performed by alternately switching between two reserve electric-discharge pulses in a positive polarity and in a reverse polarity, a better process may be performed by differentiating an application mode of a main electric-discharge pulse applied following each reserve electric-discharge pulse. That is, by changing a current waveform shape of a main electric-discharge pulse corresponding to a polarity of a reserve electric-discharge pulse to mutually differentiate current waveform shapes, a processing current shape may be optimized to match an electric-discharge characteristic and a high-precision process may be performed. As described above, to change a current waveform shape corresponding to a polarity of a reserve electric-discharge pulse, input energy is changed according to an electric discharge characteristic by changing an electric charge amount, and a current peak value is changed, for example.

Further, by greatly differentiating the amount of the reserve electric-discharge current itself, an optimum process may be performed by more conspicuously reflecting characteristics of a positive polarity and a reverse polarity.

Furthermore, by properly setting a pause time from when a main electric-discharge pulse is turned off until when a reserve electric-discharge pulse is applied, characteristics of a positive polarity and a reverse polarity of a reserve electric-discharge pulse may be more efficiently drawn out. That is, a high-precision process may be performed by setting a pause time corresponding to an electric discharge characteristic, for example, by setting the pause times S1 and S2 at mutually different values.

The parameters described above to be changed corresponding to an electric discharge characteristic are mutually independent, and are not necessarily required to be combined to satisfy all parameters. For example, the pause time S1 may be set shorter than the pause time S2 (influence of a positive polarity is large) while setting the resistance of the current limit resistor R2 smaller than that of the current limit resistor R1 (influence of a reverse polarity is large).

Characteristics of an electric-discharge start voltage are described next.

A primary object of a reserve electric-discharge pulse is to induce electric discharge. Characteristics of a positive polarity and a reverse polarity are characteristics in processing, that is, characteristics of an electric discharge current flowing after electric discharge is started, and are different from a phenomenon of insulation breakdown that becomes a trigger of electric discharge. A moment of starting electric discharge has different characteristics between a cathode and an anode, and therefore an optimum value is present. An electric discharge gap changes based on a wire and a behavior of processing, and varies in the order of several dozens of milliseconds to several hundred milliseconds. An electric discharge gap may be assumed to change little in view of an interval between electric discharges applied in the order of several microseconds to several dozens of microseconds. In this case, when an electric-discharge start voltage is different depending on a material, a time before electric discharge starts (an electric-discharge delay time) is different when the voltages V1 and V2 of the reserve electric-discharge pulse A and the reserve electric-discharge pulse B are the same.

When a wire electrode is a substance which may easily electrically discharge and which has a positive polarity working as a cathode (the reserve electric-discharge pulse A), this case is explained with reference to FIG. 2. When V1=V2, a time from when the reserve electric-discharge pulse A is applied until when electric discharge is detected and the pulse stops (t1−t0) tends to become shorter than an application time (t5−t4) of the reserve electric-discharge pulse B. Conversely, an application time of the reserve electric-discharge pulse B is unnecessarily long. This leads to reduction of an electric discharge frequency, and therefore the processing speed decreases. To properly keep processing efficiency, it is preferable that an electric discharge delay time is substantially constant for the reserve electric-discharge pulse B and for the reserve electric-discharge pulse A. Application voltages need to be differentiated accordingly. In the above case, voltages may be set as V2>V1 to shorten an electric-discharge delay time of the reserve electric-discharge pulse B.

By selecting an electric discharge voltage to set the same electric-discharge probability, a processing gap becomes stable, electric discharge efficiency may be improved, and the processing speed may be improved.

Because a relationship between V1 and V2 is different depending on a material, it cannot be decisively said but it is better to design such that V2>V1 by selecting a material of a satisfactory electric discharge characteristic (a material of a low electric-discharge start voltage) for a wire electrode because a wire electrode can be selected relatively freely for a workpiece. A material of a low electric-discharge start voltage is Zn and the like, for example.

<Problems of Conventional Technique>

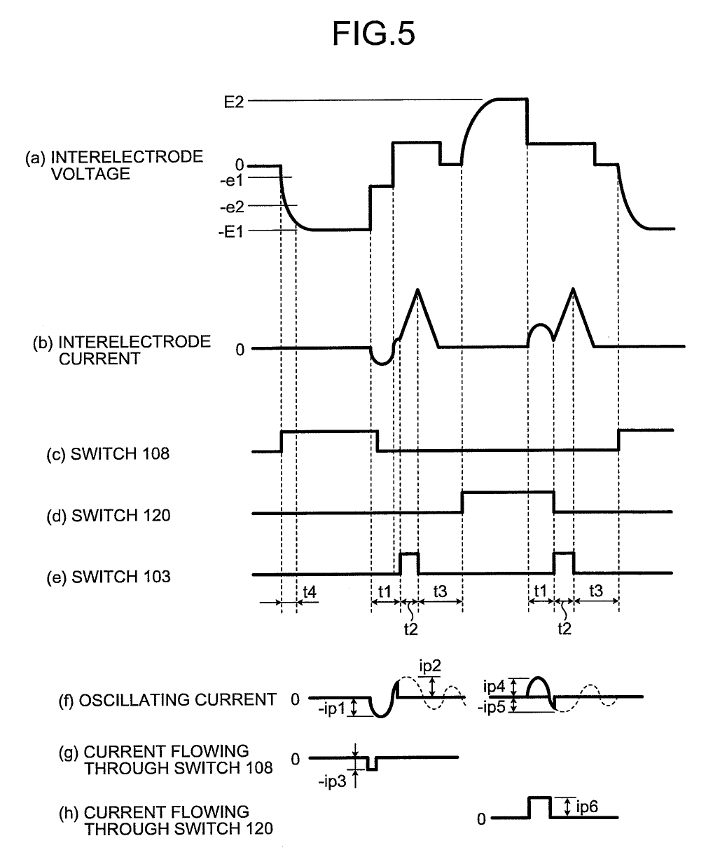

FIG. 4 is a circuit configuration diagram of the wire electric discharge device described in Patent Document 1. FIG. 5 depicts a switching signal waveform described in Patent Document 1. As shown in FIG. 4, a conventional wire electric discharge device includes an electrode 101, a workpiece 102, a first switch 103, a first direct-current power source 104, an electrically conductive chip 105, a surge-voltage absorbing circuit 106, a diode 107, a second switch 108, a second direct-current power source 109, a resistor 110, a capacitor 112, an inductance 113, a resistor 114, a control circuit 115, drive circuits 116 and 117, a third switch 120, a third direct-current power source 121, a resistor 122, a drive circuit 123, diodes 124, 125, and 126, and signal lines 127 and 128.

In FIG. 4, the second direct-current power source 109 and the third direct-current power source 121 are reserve electric-discharge power sources to apply a reserve electric-discharge pulse, and the first direct-current power source 104 is a main electric-discharge power source to apply a main electric-discharge pulse. The conventional wire electric discharge device uses water for a processing liquid. Therefore, a reserve electric-discharge pulse is generated by replacing processing polarities by alternately applying the second direct-current power source 109 and the third direct-current power source 121 to prevent electric corrosion. On the other hand, a main electric-discharge pulse greatly contributing to processing is generated in a positive polarity process using the workpiece 102 as a positive electrode and the electrode 101 as a negative electrode.

In FIG. 5, when the switch 108 is turned on, a current flows in a loop of the second direct-current power source 109-the electrode 101-the workpiece 102-the diode 125-the switch 108-the second direct-current power source 109, and a reserve electric-discharge pulse is applied in a gap between electrodes. The switch 108 is turned off and the switch 103 is turned on after a period t1 when electric discharge is detected, thereby supplying a main electric-discharge pulse in a loop of the first power source 104-the workpiece 102-the electrode 101-the diode 124-the switch 103-the first power source 104 (the period t2). In a period t3, a pause time is provided during which a current flowing in a floating reactor is regenerated and a current is down between electrodes at the same time when the main electric-discharge pulse is stopped. Thereafter, when the switch 120 is turned on, a current flows in a loop of the third direct-current power source 121-the workpiece 102-the electrode 101-the diode 126-the switch 120-the third direct-current power source 121, and a reserve electric-discharge pulse in a polarity different from a preceding polarity is applied to a polarity. When the switch 120 is turned on after the period t1 when electric discharge is detected, and when the switch 103 is turned on during the period t2, a main electric-discharge pulse is applied in a gap between electrodes.

In Patent Document 1, a main electric-discharge pulse applied after a reserve electric-discharge pulse is maintained to be on during the period t2 when the pulse has the same pulse width regardless of its polarity. However, because electric discharge characteristics are different between a cathode and an anode, electric discharge at an application time of a reserve electric-discharge pulse can be also considered to have a different electric discharge mode. For example, when a workpiece works as a cathode, the main electric-discharge pulse has a shape of a small diameter with a high current density having a cathode spot, and when the workpiece works as an anode, the main electric-discharge pulse has a shape of a large diameter with a low current density. Although a main electric-discharge pulse after an application of the reserve electric-discharge pulse is standardized in a positive polarity process, in an initial period of the main electric-discharge pulse, the main electric-discharge pulse is considered to have an electric-discharge characteristic at the application time of the reserve electric-discharge pulse. Particularly, when an electric discharge current of a main electric-discharge pulse in a finishing process and the like becomes small, the difference between a reserve electric-discharge pulse and a processing current (processing energy) also becomes small. Therefore, influence of an electric discharge state at a reserve electric-discharge time can be considered to remain large by this size. According to the conventional electric discharge device, a main electric-discharge pulse is applied similarly regardless of the polarity at a reserve electric-discharge application time. Therefore, there is a problem in that it is difficult to perform a high-precision process by sufficiently taking advantage of a capacity of a positive polarity process or a reverse polarity process. The present embodiment solves this problem of the conventional technique.

### INDUSTRIAL APPLICABILITY

As described above, the electric discharge device according to the present invention is useful as an invention capable of performing a high-precision and high-functional process by selecting an optimum method as needed, corresponding to elements such as high speed, low consumption, high surface accuracy, and high straightness accuracy.

1-6. (canceled)

7. An electric discharge device that performs an electric discharge process by applying in a gap between a process electrode and a workpiece a reserve electric-discharge pulse output by alternately switching polarities and a main electric-discharge pulse output after detecting electric discharge by the reserve electric-discharge pulse, wherein
when processing is performed by providing a pause time after an application of the main electric-discharge pulse,
a pause time provided after an application of a reserve electric-discharge pulse in a positive polarity output by setting the workpiece as a positive electrode and the process electrode as a negative electrode, and
a pause time provided after an application of a reserve electric-discharge pulse in a reverse polarity output by setting the workpiece as a negative electrode and the process electrode as a positive electrode
are set mutually different.

8. An electric discharge device that performs an electric discharge process by applying in a gap between a process electrode and a workpiece a reserve electric-discharge pulse output by alternately switching polarities and a main electric-discharge pulse output after detecting electric discharge by the reserve electric-discharge pulse, wherein
regarding an application voltage of a reserve electric-discharge pulse in a positive polarity output by setting the workpiece as a positive electrode and the process electrode as a negative electrode, and
an application voltage of a reserve electric-discharge pulse in a reverse polarity output by setting the workpiece as a negative electrode and the process electrode as a positive electrode,
the application voltage of a reserve electric-discharge pulse in a reverse polarity is set larger.
